(19) United States
(12) Patent Application Publication
(10) Pub. No.: US 2012/0099918 A1
(43) Pub. Date: Apr. 26, 2012

(54) Mass Producible Mascara Tube, Method For Producing Same, And Use Thereof

(75) Inventor: Gery Bernard Marie Cornil Dambricourt, Escoutoux (FR)

(73) Assignee: CEP TUBES, Saint-Remy-Sur-Durolle (FR)

(21) Appl. No.: 13/148,711

(22) PCT Filed: Feb. 17, 2010
(86) PCT No.: PCT/FR10/50266

§ 371 Date: Nov. 9, 2011

(30) Foreign Application Priority Data
Feb. 17, 2009 (FR) 0951036

(51) Int. Cl. A45D 40/26; A45D 34/04; B23P 17/00

(52) U.S. Cl. 401/122; 29/527.1

(57) ABSTRACT

A tube, for example for mascara, has a container equipped with a receptacle, a chamber and a wiping ring, and an applicator including a brush, a cap and an axial rod connecting the brush to the cap, in which the rod ensures closure of the wiping ring, and the ring has an internal diameter adapted to the specifications of the brush. According to the invention, the rod has an annular closure surface with a non-zero radial dimension, and the closure of the wiping ring by the rod is performed by applying the annular closure surface on the ring in an area of mutual contact having a non-zero radial dimension.

### BACKGROUND

The invention relates, in general, to the production of cosmetic accessories.

More specifically, the invention relates, according to a first aspect, to a tube, in particular a mascara tube, including a container and an applicator, in which the container includes an elongate receptacle according to a longitudinal axis, a wiping chamber, and a wiping ring arranged between the chamber and the receptacle, in which the applicator includes a brush selectively arranged in the receptacle, a cap selectively closing an opening of the container opening onto the chamber, and an axial rod connecting the brush to the cap, in which the rod selectively ensures closure of the wiping ring, and said ring has an internal diameter adapted to the specifications of the brush.

In spite of their apparent simplicity, mascara tubes involve very specific production problems.

These tubes indeed use a wide variety of brushes designed to meet the desires of users according to their tastes and the characteristics of their eyelashes.

However, insofar as the wiping ring must be adapted to the specifications of the brush, and insofar as the rod must close the wiping ring, the rod must itself be adapted to the brush.

Therefore, a type of rod and a type of wiping ring corresponds to each type of brush, with each type of ring having a predetermined internal diameter.

Under these conditions, the production of a mascara tube model offering, for example, fifteen different types of brushes presents immediate automation problems.

### SUMMARY OF THE INVENTION

In this context, this invention is intended to propose a tube, in particular a mascara tube, of which the structure enables this problem to be overcome.

To this end, the tube of the invention, which is consistent with the general definition provided in the preamble above, is essentially characterized in that the rod has an annular closure surface with a non-zero radial dimension, in that the closure of the wiping ring by the rod is performed by applying the annular closure surface on the ring in an area of mutual contact having a non-zero radial dimension, in that the rod is partially formed by a longitudinal extension of the cap, in that said annular closure surface belongs to this longitudinal extension, and in that, even after the applicator is removed from the container, the internal diameter of the wiping ring is greater than the minimum diameter of the longitudinal extension of the cap.

Owing to this arrangement, it is possible to modify the internal diameter of the wiping ring without losing the closure provided by the longitudinal extension of the cap by contact of its annular closure surface on the wiping ring.

Preferably, the container is obtained by molding in a single piece.

The area of mutual contact of the longitudinal extension of the cap and the wiping ring can be formed as a disk, or more advantageously as a cone frustum in order to be capable of providing a larger contact surface.

In addition to said longitudinal extension of the cap, the rod includes, for example, a core holding the brush and engaged in an axial recess of said longitudinal extension.

In the tube of the invention, the container and the cap, including the longitudinal extension of said cap, can be made of a thermoplastic material.

In addition, the production of said tube can be facilitated by ensuring that the container and the cap have respective cylindrical external walls.

Insofar as it can be produced in an at least partially automated manner and therefore at very low cost, the tube of the invention can easily be applied in the production of commercial samples.

The invention also relates to a process for producing a tube as defined above, which process is characterized in that it includes at least the operations consisting of:
producing, at least by molding, an intermediate part differing from the container in that it has two open ends of which the first forms the opening leading onto the wiping chamber and of which the second is opposite the first;
producing the cap and the longitudinal extension by molding in a single piece;
inserting the core holding the brush into the axial recess of the longitudinal extension;
closing the end of the intermediate part, forming the opening leading onto the wiping chamber by mounting the cap;
injecting mascara into the intermediate part through the second end opposite the first; and
closing by sealing said second end.

The process of the invention can also include an operation implemented, before the molding and consisting of selecting, and placing in the mold intended for said molding, an attached part determining the internal diameter of the wiping ring.

Alternatively, the process of the invention can include an operation implemented after the production and before the sealing of the intermediate part and consisting of enlarging, by removing material, the internal diameter of the wiping ring.

### BRIEF DESCRIPTION OF THE DRAWINGS

Other features and advantages of the invention will become clear from the following description, provided for indicative and non-limiting purposes, in reference to the appended drawings, in which:

FIG. 1 is an elevation view of a tube according to a preferred embodiment of the invention;

FIG. 2 is an elevation view of an intermediate production product intended to form a tube as shown in FIG. 1;

FIGS. 3A to 3C are cross-section views of intermediate production products such as that shown in FIG. 2, in which said different products result from the same production process but have respective wiping rings with different internal diameters;

FIG. 4 is a cross-section view of a detail of FIG. 3A; and

FIG. 5 is a cross-section view of an alternative of the detail shown in FIG. 4.

### DETAILED DESCRIPTION OF THE PREFERRED EMBODIMENT(S)

As indicated above, the invention relates to a mascara tube including a container 1 and an applicator 2.

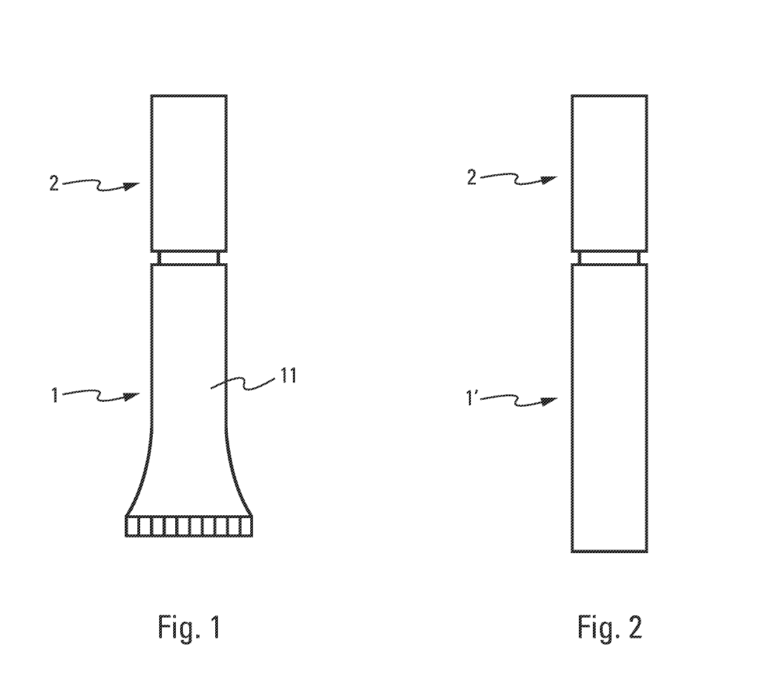

In the figures, the container 1 is in fact visible in its final form only in FIG. 1.

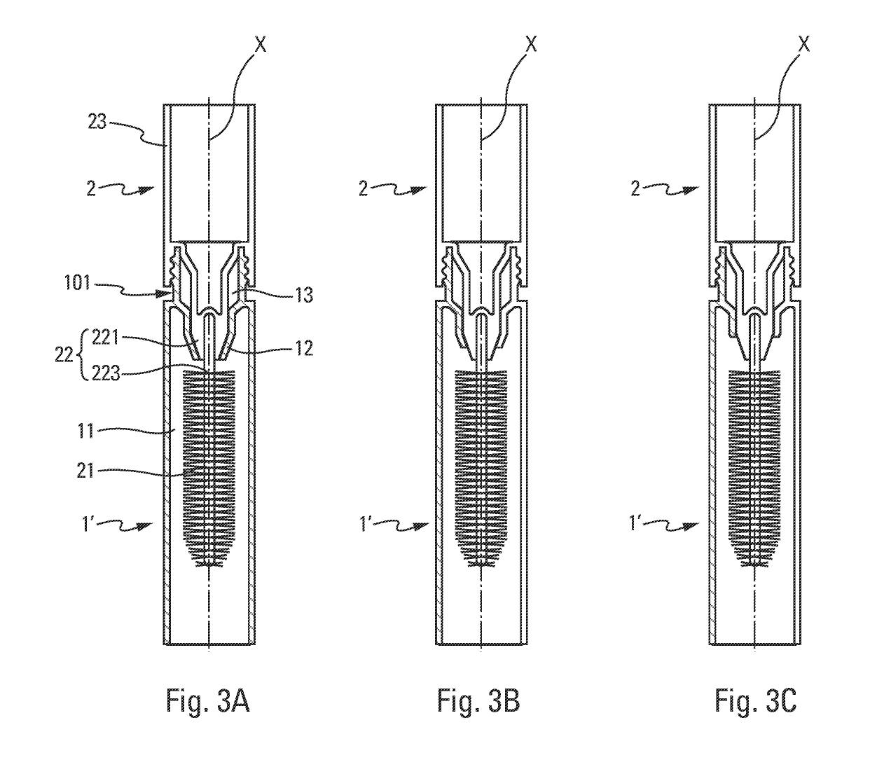

Indeed, in the preferred embodiment of the invention, which is shown in the figures, the container 1 is obtained by molding in a single block, by injection, an intermediate production part 1′ which is visible in FIGS. 2 and 3A to 3C.

This intermediate part 1′ has two opposite and open ends, respectively referenced 101 and 102, and of which the second is subsequently closed off by sealing.

Insofar as the sealing constitutes the single significant transformation enabling the container 1 to be obtained from the intermediate part 1′, the next part of this description will liken the intermediate part 1′ to the container 1 for the presentation of all of the other features relating to the container.

This container 1 includes a receptacle 11, a wiping chamber 13, and a wiping ring 12.

The wiping ring 12 is arranged between the chamber and the receptacle 11, which receptacle is itself elongate according to a longitudinal axis X.

The applicator 2 includes a brush 21, a cap 23, and an axial rod 22 connecting the brush 21 to the cap 23.

Aside from reliefs provided in order to cooperate with the cap 23, the container 1 is, at least essentially, formed by a wall with a substantially constant thickness, with the angle of clearance close to what is required for disassembly of the intermediate part 1′.

Nevertheless, the wiping ring 12 can have a wall thickness that, while be substantially constant over its entire surface, is less than the thickness of the wall of the receptacle 11.

In addition, the wall of the receptacle 11 can be slightly finer in the vicinity of the end 102 of the intermediate production part 1′ in order to facilitate the folding and welding of said end.

After production of the tube of the invention, i.e. when it is ready for use, the brush 21 is inserted into the receptacle 11, which is filled with mascara, and the cap 23 is screwed onto the end 101 of the container so as to close the opening 100 of said container at said end, and which opens onto the wiping chamber 13.

More specifically, the cap 23 has an annular area 103 that cooperates with the end 101 of the container in order to ensure the seal between said cap and said container when the tube is closed.

In addition, the rod 22 then adopts a position in which it closes the wiping ring 12 thus ensuring tightness between the receptacle 11 and the chamber 13, which ring also has an internal diameter adapted to the specifications of the brush 21.

According to the invention, the rod 22 has an annular closure surface 222 with a non-zero radial dimension.

In the embodiment shown, the rod 22 is partially formed by a longitudinal extension 221 of the cap 23, and the annular surface 222, which is therefore by definition not parallel to the longitudinal axis X, is arranged on this longitudinal extension 221.

Under these conditions, the closure of the wiping ring 12 by the rod 22 is achieved by applying the annular closure surface 222 on the ring 12, in an area of mutual contact that itself has a non-zero radial dimension.

Although the mutual contact area between the annular closure surface 222 and the ring 12 can have a disk shape, i.e. it can extend only in a plane transversal to the axis X, this mutual contact area is preferably frusto-conical, as shown in the figures, so as to have a larger area.

As shown in FIGS. 3A to 5, the rod 22 advantageously includes, in addition to the longitudinal extension 221 of the cap, a core 223, for example metal, that holds the brush 21 and that is engaged in an axial recess 220 of said longitudinal extension 221.

The tube of the invention can be mass produced in an automated manner by implementing the following operations.

In a first phase, the intermediate part 1′ and the cap 23 are first molded by injection of a thermoplastic material.

In this first phase, the intermediate part 1′ is molded in a single piece including the part that will become the receptacle 11, the wiping ring 12, and the wiping chamber 13 with its threading if the cap 23 is attached on the container 1 by screwing.

The cap 23 is preferably molded in a single piece with its longitudinal extension 221, with the axial recess 220 advantageously also being formed during said molding.

It may be advantageous, in order to facilitate the implementation of this first phase, for the container 1 and the cap 23 to respectively have external cylindrical walls.

As a person skilled in the art will understand, the term “cylindrical” as used here applies to any shape that does not differ from a cylinder in the mathematical sense except by a clearance angle necessary for the de-molding of said shape.

The following operations consist of inserting the core 223 of the brush 21 into the axial recess 220 of the longitudinal extension 221 and closing the opening 100 by screwing or mounting of the cap 23 on the end 101 of the intermediate part 1′.

The core 223 of the brush can be inserted in the axial recess 220 by force fitting, setting, induction or any other suitable means.

The following operations consist of injecting mascara into the intermediate part 1′ through the end 102 distant from the cap 23.

It is then sufficient to seal the end 102 of the intermediate part 1′ in order to transform it into a container 1, and the tube is then functionally ready for use.

Classically, and in particular if the tube of the invention is intended to be a commercial sample, the filling and sealing of the container 1 are preceded by a marking operation consisting of applying a design on the external wall of the container 1 or the cap 23.

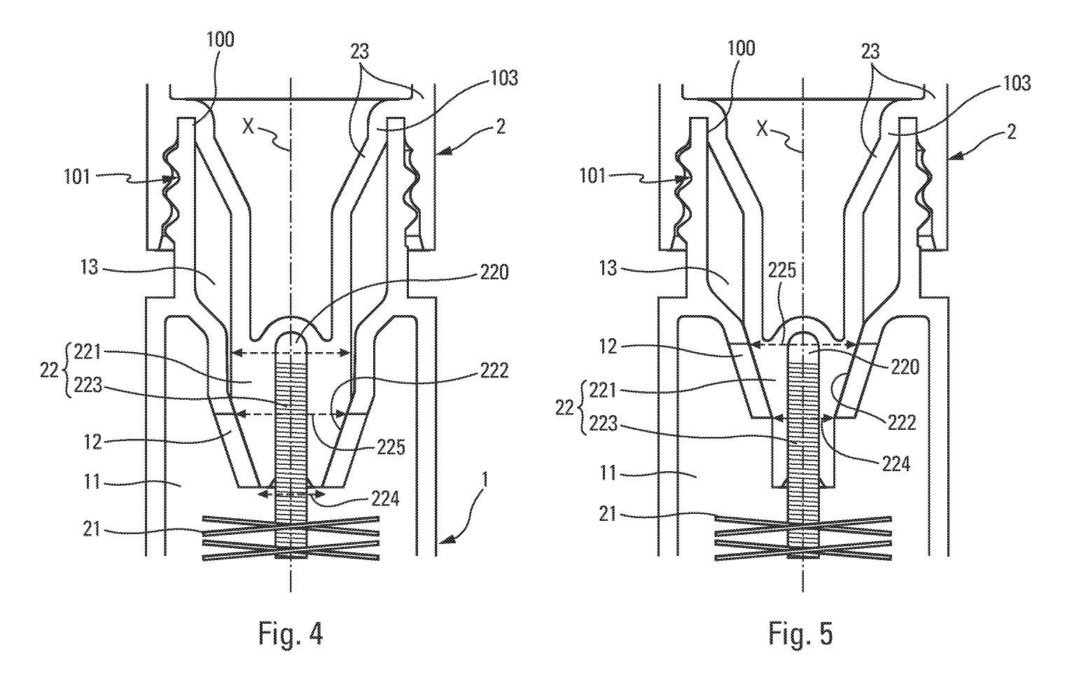

The operations described above make it possible to produce a tube equipped with a wiping ring 12 having an internal diameter of which the value is between a minimum dimension 224 and a maximum dimension 225 as shown in FIG. 4 or FIG. 5.

The minimum dimension 224, which the wiping ring 12 reaches in the place where the wall forming it is interrupted, is greater than the diameter of the core 223 of the brush.

The maximum dimension 225 of the wiping ring 12 has a diameter sufficient to preserve a minimum surface of closure on said wiping ring.

The main advantage of the invention lies in the possibility of modulating the diameter of the wiping ring between the minimum dimension 224 and the maximum dimension 225.

More specifically, according to the invention, even after the applicator 2 has been removed from the container 1, the internal diameter of the wiping ring 12 must be greater than the minimum diameter of the longitudinal extension 221 of the cap 23.

In practice, as shown in FIGS. 3B and 3C, the real clearance between the wiping ring 12 where it has its smallest internal diameter, and the portion of the longitudinal extension 221 of the cap 23 that has the minimum diameter can even be clearly greater than the functional clearance necessary for the passage, through said ring, of said minimum diameter portion of said longitudinal extension 221, and, for example, at least equal to twice said functional clearance.

The value desired for the internal diameter of the wiping ring can be obtained directly during the molding operation of the container, by placing an interchangeable part in the mold, which part is selected from a set of interchangeable parts of different sizes, forming a core for said ring during molding, and therefore defining the internal diameter of said ring.

Alternatively, the desired value for the internal diameter of the wiping ring can be obtained by increasing said diameter afterward by machining and removal of excess material.

Although this description frequently refers to a mascara tube, and although the term “brush” has been used, for the sake of convenience and clarity, instead of the term “application tool”, a person skilled in the art will understand that the invention is more generally applicable to application devices including a container and an applicator, in which the applicator includes a cap and an application tool connected by a rod, in which the container includes a receptacle, a wiping ring and a wiping chamber, and the application tool is intended to be wiped before use.

The invention therefore applies in a non-limiting manner to all types of flexible application tools, such as, for example, flocked end pieces or end pieces intended for lip gloss, which are wiped before use.

FIGS. 4 and 5 show two possible solutions.

Preferably, shown in FIG. 4, the annular closure surface is located at the end of the extension 221 of the cap opposite the cap so that said extension, which is then totally housed in the chamber when the mascara tube is closed, is not in contact with the mascara, or more generally with the product contained in the receptacle.

A second embodiment of the invention consists of producing the receptacle and the wiping ring in two parts, so that the container is obtained by a preliminary assembly of said two parts, and the wiping chamber is integral with the receptacle or with the wiping ring.

In this second embodiment, the end 102 of the receptacle opposite the end 101 opening onto the wiping chamber is closed during the receptacle molding operation, thereby making it possible to produce a cylindrical tube over the entire length thereof.

In this second embodiment, the mascara is introduced by the end 102 of the receptacle prior to a final tube closing operation by assembly of the cap and the container.

1-10. (canceled)

11. A tube including:
a container and an applicator;
the container including an elongate receptacle according to a longitudinal axis (X), a wiping chamber, and a wiping ring arranged between the wiping chamber and the elongate receptacle;
the applicator including a brush selectively arranged in the elongate receptacle, a cap selectively closing an opening of the container opening onto the wiping chamber, and an axial rod connecting the brush to the cap, in which the axial rod selectively ensures closure of the wiping ring:
said wiping ring having an internal diameter adapted to specifications of the brush, the axial rod having an annular closure surface with a non-zero radial dimension;
the closure of the wiping ring by the rod being performed by applying the annular closure surface on the wiping ring in an area of mutual contact having a non-zero radial dimension;
the axial rod being partially formed by a longitudinal extension of the cap; said annular closure surface belonging to the longitudinal extension; and even after the applicator is removed from the container, the internal diameter of the wiping ring being greater than a minimum diameter of the longitudinal extension of the cap.

12. The tube according to claim 11, wherein the container is a molded single piece.

13. The tube according to claim 11, wherein the area of mutual contact is formed as a cone frustum.

14. The tube according to claim 11, wherein the area of mutual contact is formed as a disk.

15. The tube according to claim 11, wherein the axial rod includes in addition to said longitudinal extension of the cap, a core holding the brush and engaged in an axial recess of said longitudinal extension.

16. The tube according to claim 11, wherein the container, the cap, and the longitudinal extension of said cap, are made of a thermoplastic material.

17. The tube according to claim 11, wherein the container and the cap have respective cylindrical external walls.

18. The tube according to claim 11, wherein said tube is a mascara tube.

19. The tube according to claim 11, comprising a commercial sample.

20. Process for producing a tube according to claim 15, comprising at least the steps of:
producing, at least by molding, an intermediate part differing from the container in that said intermediate part has two open ends of which a first open end forms the opening leading onto the wiping chamber and of which a second open end is opposite of the first open end;
producing the cap and the longitudinal extension by molding said cap and said longitudinal extension in a single piece;
inserting the core holding the brush into the axial recess of the longitudinal extension;
closing the first open end of the intermediate part by mounting the cap;
injecting mascara into the intermediate part through the second open end of said intermediate part; and
closing by sealing the second open end of the intermediate part.

21. The process according to claim 20, further comprising implementing an operation before the molding step and consisting of selecting and placing in a mold intended for said molding an attached part determining the internal diameter of the wiping ring.
